(19) United States
(12) Patent Application Publication
(10) Pub. No.: US 2007/0027981 A1
(43) Pub. Date: Feb. 1, 2007

(54) Computer diagnostic system

(76) Inventors: Giovanni Coglitore, Saratoga, CA (US); John M. Twilley, Fremont, CA (US); Lawrence B. Seibold, San Jose, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/191,602

(22) Filed: Jul. 27, 2005

(51) Int. Cl. G06F 15/173

(52) U.S. Cl. 709/224

(57) ABSTRACT

A monitoring system for providing status information about a computer system is provided. The monitoring system includes: a system interface configured to couple with a corresponding interface on a motherboard of the computer system; a display to visually indicate a status of the computer system; a nonvolatile memory; a network interface for connection with a data communications network; and a programmable controller configured to communicate with a management system via the network interface, to cause the display to indicate a status of the computer system, and to store the status of the computer system in the nonvolatile memory.

### BACKGROUND

Due to the frequent occurrence of failures in computer systems, it is important that the computer administrator have some mechanism for monitoring the status of operation of the computer, to ensure that the computer is continuing to function properly. One conventional way of monitoring a computer system is by requesting status information using a standard input device, such as a mouse and keyboard, and by viewing the status information on a display directly coupled to the computer system.

When large numbers of computer systems are deployed, this type of direct interaction with each computer system can become burdensome and consume a large amount of the administrator's time. For example, a data center may include multiple rows of rack-mounted computer systems. The monitoring and management of each of these computer systems can be an overwhelming task.

In another example, in some computer assembly facilities, large numbers of computer systems may undergo testing for extended periods of time before being shipped to customers. In many cases, these computer systems are not connected to a computer network, and are continuously executing a test application on a standalone basis. In these facilities, a technician may physically visit each computer to attach a computer monitor and check the status of the tests being performed. When a failed system is detected, the system may be physically removed from the testing site and brought to a separate station for further analysis and repair. Because the computer system is shut down when it is removed from the testing site, it is generally not possible to detect the type of failure when the system is brought to the repair station without having to reboot the computer. Accordingly, the technician may have to separately record the type of failure so that the computer need not be rebooted and retested when it is brought to the repair station.

The Intelligent Platform Management Interface (IPMI) standard has been developed to enable computer administrators to monitor system hardware and sensors, control system components, and retrieve logs of important system events to conduct remote management and recovery. IPMI is implemented as firmware running on a dedicated controller chip. This arrangement is sometimes referred to as the Baseboard Management Controller (BMC). The BMC can communicate with an administrator at a remote console out-of-band (e.g., through a network connection separate from the network connection used by computer system motherboard), so that the administrator can receive information regarding the status of the computer system and any failures even if the computer's operating system has crashed. One limitation of IPMI-based systems is that the BMC is integrated into the motherboard for the computer system. Therefore, the monitoring and management functions provided by IPMI are not available for existing off-the-shelf, non-IPMI-compliant motherboard designs.

Accordingly, it would be desirable to provide an improved system for monitoring and managing computer systems. This is particularly important when large numbers of computer systems are deployed, such as in large data centers or in computer assembly testing facilities.

### SUMMARY

A monitoring system for providing status information about a computer system is provided. The monitoring system includes: a system interface configured to couple with a corresponding interface on a motherboard of the computer system; a display to visually indicate a status of the computer system; a nonvolatile memory; a network interface for connection with a data communications network; and a programmable controller configured to communicate with a management system via the network interface, to cause the display to indicate a status of the computer system, and to store the status of the computer system in the nonvolatile memory.

In accordance with other embodiments of the present invention, a monitoring system for a computer system is provided, comprising: a serial interface configured to couple with a corresponding serial interface on a motherboard of the computer system; a display to visually indicate a status of the computer system; a network interface for connection with a data communications network; and a programmable controller configured to cause the display to indicate a status of the computer system, wherein the programmable controller is configured to receive a management command via the network interface in accordance with a first messaging protocol, to convert the management command to an instruction according to a second messaging protocol, and to transmit the instruction to a device in the computer system via the serial interface.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### DESCRIPTION OF THE DRAWINGS

FIG. 1 shows a block diagram of an exemplary computer system and monitoring system, in accordance with an embodiment of the present invention.

FIG. 2 is a simplified block diagram of an exemplary environment in which the monitoring system may be deployed.

FIG. 3 shows a front view of an exemplary computer system, in accordance with an embodiment of the present invention.

FIGS. 4A-4B illustrate a display for displaying a barcode, in accordance with embodiments of the present invention

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

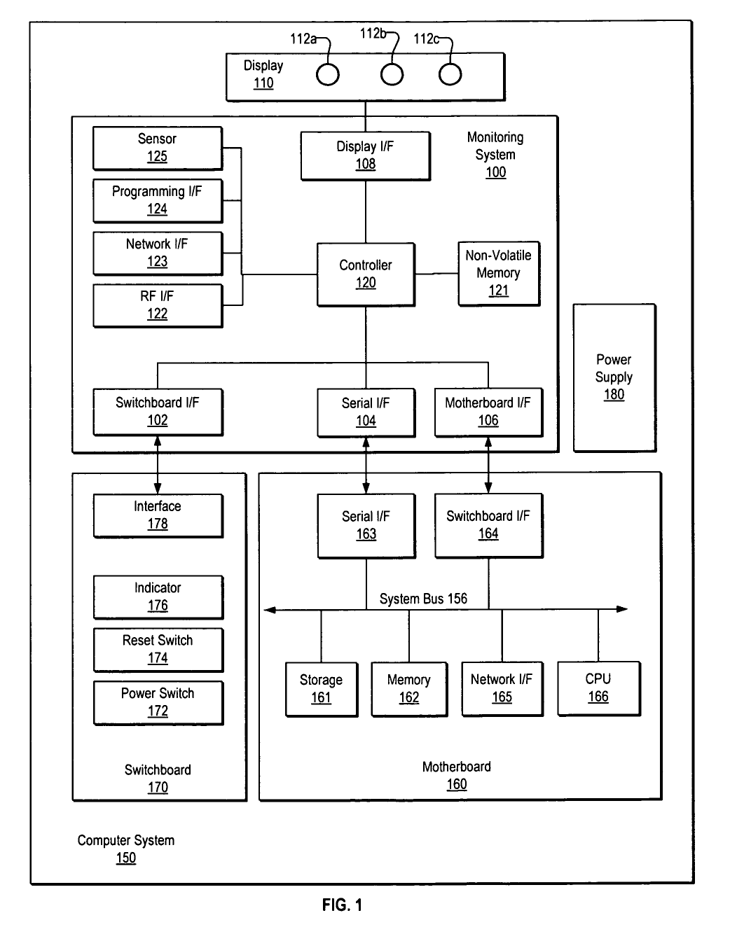

FIG. 1 shows a block diagram of an exemplary computer system 150 and a monitoring system 100 for providing status information about the computer system 150, in accordance with an embodiment of the present invention. The computer system 150 may comprise any electronic system designed to perform computations and/or data processing. The computer system 150 comprises a printed circuit board (PCB) motherboard 160, having various components connected to the motherboard 160 or mounted thereon. In the illustrated embodiment, the motherboard 160 includes a system bus 156, which connects a central processing unit (CPU) 166, a memory 162, storage 161 (such as a hard disk drive), a network interface 165, a serial interface 163, and a switchboard interface 164. It is understood that the computer system 150 also includes other components not shown in FIG. 1. The computer system 150 is configured to utilize an operating system, such as Microsoft Windows XP, UNIX, LINUX, etc., to manage hardware resources and to provide a platform for the execution of software programs using the CPU 166.

The computer system 150 also includes a switchboard 170, which is accessed by a user facing the computer system 150. This switchboard 170 may include a variety of interfaces, such as a power switch 172, and reset switch 174, and one or more status indicators 176 (e.g., a power LED and a hard drive activity LED). The switchboard 170 also includes an interface 178, which is typically directly coupled to pins provided on the switchboard interface 164 on the motherboard 160. As will be described in greater detail below, the switchboard 170 shown in FIG. 1 is coupled to the switchboard interface 164 via the monitoring system 100.

In some embodiments, the computer systems 150 comprise server-class computers. A server is a computer on a network that manages network resources. The server may be dedicated to a particular purpose and may store data and/or perform various functions for that purpose. In other embodiments, the computer systems 150 may comprise storage arrays. Other types of computer systems may also be used.

In some cases, the computer system 150 may include a video driver coupled to a display device, such as a CRT (cathode ray tube) or LCD (liquid crystal display) monitor, and one or more input devices, such as a mouse and keyboard. The display device and input devices can be utilized by an administrator to interact with the computer system 150. In other cases, such as in rack-mounted computer systems or computer systems undergoing assembly testing, no display or input devices are provided.

The monitoring system 100 comprises a programmable controller 120, which is coupled to a plurality of interfaces. As shown in FIG. 1, the controller 120 is coupled to a system interface (shown as serial interface 104) for interfacing with the motherboard 160 of the computer system 150. The controller 120 is also coupled to a switchboard interface 102 for coupling with the interface 178 of the switchboard 170, and a motherboard interface 106 for coupling with the switchboard interface 164 of the motherboard 160. The coupling between interfaces may be accomplished by using, e.g., one or more ribbon cables or other type of connection.

The controller 120 is also coupled to a non-volatile memory 121 for storing status information about the computer system 150, a network interface 123 for providing a connectivity to a data communications network, and a display interface 108 for coupling with a display 110. The network interface 123 may comprise, e.g., an Ethernet port. The display 110 may comprise a PCB having one or more LEDs (light emitting diodes) mounted thereon. These LEDs can be selectively illuminated to indicate status information regarding the computer system 150.

The monitoring system 100 may also include a programming interface 124. This interface 124 can be used to connect a computer system to the monitoring system 100 to program the controller 120. The monitoring system 100 may also include an RF (radio frequency) interface 122 and one or more sensors 125, which can be used to monitor various environmental conditions, as will be described in greater detail below.

The monitoring system 100 may comprise a single PCB having the various components forming the monitoring system 100 mounted thereon. This PCB may be adapted to be mounted onto the motherboard 160 or the chassis of the computer system 150, such that the display 110 is viewable through an aperture formed in the front side of the computer system 150. In other embodiments, the display 110 may be mounted onto a separate PCB connected to the PCB forming the remaining components of the monitoring system 100. In yet other embodiments, the monitoring system 100 may be adapted for mounting on the outside of the computer system chassis, in which case a cable or other connector may be used to couple the monitoring system 100 to the motherboard 160 of the computer system 150. The monitoring system 100 may then be mounted to an exterior chassis wall or to a structure adjacent to the computer system 100, such as the frame of the rack assembly in which the computer system 150 is mounted.

The monitoring system 100 may be powered by the power supply 180 through its connection with the motherboard 160 of the computer system 150. For example, the motherboard interface 106 may include a power interface for receiving power from the motherboard 160. Alternatively, the monitoring system 100 may have a direct connection to the power supply 180 in the computer system 150 or to an external power supply. The monitoring system 100 may further be provided with a battery, which can be used to power the monitoring system 100 in the event of a power failure.

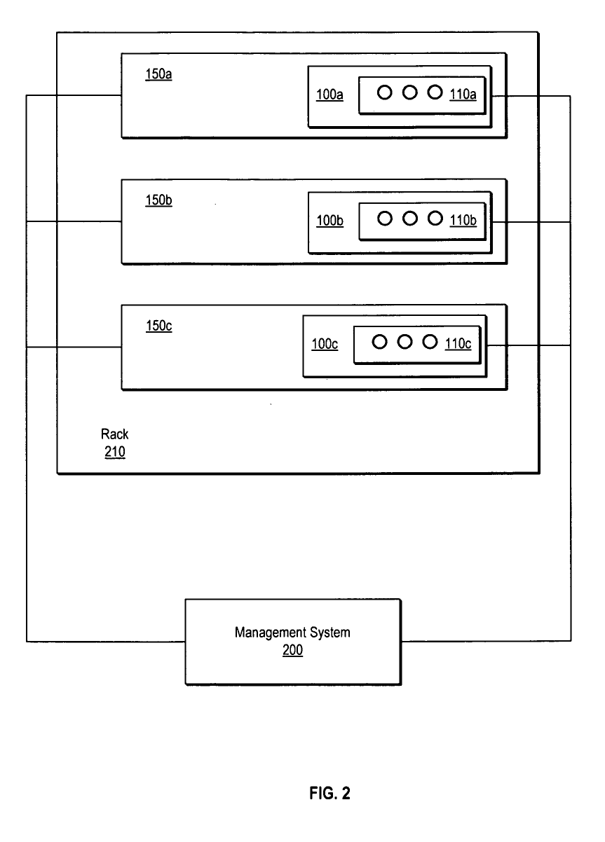

FIG. 2 is a simplified block diagram of an exemplary environment in which the monitoring system 100 may be deployed. One or more rack assemblies 210, which house a plurality of devices, such as computer systems 150a-150c). The rack assembly 210 may also house other types of devices, such as power supplies and switches.

A management system 200 is configured to communicate with the computer systems 150a-150c via the network interfaces 164, and to separately communicate with the monitoring systems 100 via the network interfaces 123. This communication can be over a LAN (local area network) or WAN (wide area network) using an IP (Internet Protocol) based communication protocol.

In the embodiment illustrated in FIG. 2, the monitoring systems 100a-100c are provided with network interfaces 123 to enable the monitoring systems 100a-100c to communicate with the management system 200 out-of-band, without utilizing the resources of the computer system 150, aside from its power supply. Thus, even if the computer systems 150a-150c have crashed or are otherwise inaccessible, the monitoring systems 100a-100c may still communicate status information to the management system 200. In other embodiments, the monitoring systems 100 may be provided with a power supply (such as a battery or a power source) separate from the computer system 150, so that even if the power supply in the computer system 150 has failed, the monitoring system 100 can remain operational.

The monitoring system 100 may also receive commands via the motherboard 160. For example, the serial interface 104 can be used to monitor peripheral inputs, such as from a keyboard or mouse attached to the computer system 150. During normal operation, the controller 120 will ignore all peripheral inputs received over the serial interface 104. However, the controller 120 may be configured to monitor the keyboard inputs for a particular predetermined sequence of inputs. Once this predetermined sequence of inputs is detected, the controller 120 will interpret subsequent keyboard inputs as commands to be executed by the monitoring system 100.

The monitoring system 100 may be used to detect a variety of different types of status information regarding the computer system 150. For example, the monitoring system 100 may receive a power status signal from the motherboard 160 via the switchboard interface 164. Normally, this power status signal is used to control the illumination of a power status light (e.g. indicator 176) provided on the front of the computer chassis to enable users to visually identify the power status of the computer system 150. However, the monitoring system 100 may be used to monitor the power status signal to detect the current power status of the computer system 150 and to transmit this status information to the management system 200.

In another example, the monitoring system 100 may detect environmental conditions, such as temperature, noise, or vibration, and report that information to the management system 200. The detection of environmental conditions can be performed using one or more sensors 125 provided in the monitoring system 100, or by retrieving environment condition information from sensors in the computer system 150.

In yet another example, the monitoring system 100 may be configured to repeatedly ping one or more components in the computer system 150, in order to confirm that those components are continuing to operate properly. For example, when a newly-assembled computer system 150 is being tested, the monitoring system 100 may be configured to transmit an acknowledgement (ACK) ping to the operating system on a periodic basis (e.g., every 10 minutes). If the operating system fails to transmit a reply ACK in response to the ACK ping, the monitoring system 100 will issue an alert. This alert may be issued in-band through the computer system 150, out-of-band through the network interface 123, visually using the display 110, or combinations of the above. This monitoring process can enable large numbers of computer systems to be monitored, while minimizing the amount of time spent by service personnel to monitor the testing. Similar types of monitoring may also be used to check for failures in computer systems 150 that are deployed in actual operation.

LED Color Sequence and Timing

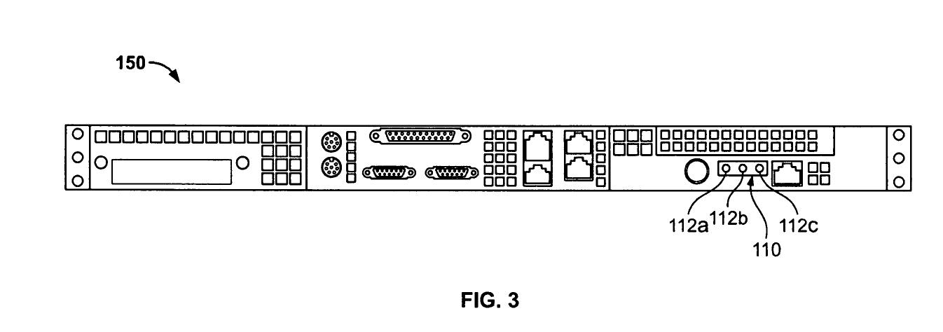

FIG. 3 illustrates the front view of an exemplary computer system 150. In this example, the computer system 150 comprises a rack-mountable server having a 1U profile, which is a common form factor for high-density server installations. The computer system 150 includes a chassis which contains the motherboard 160 and other components of the computer system 150. Typically, the chassis will include six sides to fully enclose all of the components, with vents provided in multiple sides to allow cooling air to pass therethrough. The front side of the computer system 150 is the side that is typically exposed and viewable by administrators when the computer system 150 is mounted in a rack assembly.

Due to the low profile of the 1U server (approximately 1.75 inches), very little space is available on the front bezel of the computer system 150. The available space can be made even more limited if hot-swap components, such as hard drives or power supplies, are accessible from the front side. Accordingly, it may be desirable for the display 110 to consume a minimal amount of space on the front side of the computer system 150. However, it is also desirable for the display 110 to be capable of visually conveying as much information as possible to a user.

In accordance with embodiments of the present invention, a display 110 incorporating one or more multi-color LEDs that can be selectively activated by the controller 120 to convey a plurality of types of information about the status of the computer system 150 being monitored by the monitoring system 100.

In a simple example, a single LED that is illuminated red will indicate that an event, such as a failure, has been detected. By utilizing a multi-color LED, which is capable of illuminating in several different colors. Thus, a single multi-color LED is capable of indicate as many different states as it has colors available. By utilizing multiple multi-color LEDs, the combinations of colors in the multiple LEDs can be used to indicate even more states. For example, if a display includes two three-color LEDs, then each LED has four possible states (e.g., red, green, blue, and off), and a total of 4² permutations are possible, thereby enabling the display to indicate 16 different states of the computer system 150. Similarly, if the display includes three three-color LEDs, then a total of 4³ different states may be expressed.

In addition to the use of color combinations to indicate different states of the computer system 150, the sequential activation of colors in the LEDs 112 may be used to indicate different states. For example, the controller 120 may be configured to activate the multi-color LED to illuminate red then green to indicate a particular state. Any pattern of colors may be used for each multi-color LED, combinations of the LEDs may be used to combine multiple patterns to provide additional permutations. Although the potential number of patterns is limitless, it may be desirable to limit the pattern to a short sequence of colors, e.g., two or three, in order to improve the ease and speed with which the pattern can be recognized by an administrator.

The controller 120 may also be configured to utilize the timing of the illumination of the LEDs to indicate different states of the monitored computer system. The speed with which one or more colors are flashed by an LEDs can be used to communicate different states. For example, a rapidly flashing LED can indicate an urgent problem, while a slowly flashing LED can indicate a lower priority problem. In addition, the combination of different illumination timings can be used to indicate different types of information.

The color, sequence, and timing of the activation of lights on the display 110 can be used in combination to indicate an extensive list of different states. This can be particularly helpful when an administrator is managing large numbers of servers mounted in rows of rack assemblies. As the administrator walks along a row of rack assemblies, the illuminated display 110 can immediately attract the administrator's attention, and the color, sequence, and timing of the activation of the lights can rapidly convey details of the status being reported, without requiring the use of a large screen capable of displaying textual information. In addition, the use of colored lights is advantageous for deployment in multiple countries. Unlike a text-based mode of conveying information, the color-based display 110 does not need to be reconfigured when deployed in countries where different languages are spoken.

Persistent State Diagnostics

In accordance with embodiments of the present invention, the monitoring system 100 includes a non-volatile memory 121 for persistently storing information regarding the state of the monitored computer system 150. In one example, the controller 120 is configured to store the current state of the computer system 150, so that if the power to the computer system 150 and monitoring system 100 is cut off, the last state displayed on the display 110 is stored. Thus, when power is returned to the monitoring system 100, the display 110 is again activated with the same state that was in existence at the time the power was cut off. In other embodiments, the monitoring system 100 may be provided with a battery to power the continued illumination of the display 110, even after the computer system 150 has been powered down.

This can be particularly useful for servicing failed computer systems. As described above, computer systems are typically deployed in one location and serviced in another location. Thus, when an administrator observes a computer system 150 having a display 110 indicating that a failure has occurred, the administrator need not manually record the type of failure before shutting off the computer system 150. Instead, the administrator can simply shut down the computer system 150, remove it from the rack assembly, and bring it to the service location, such as a repair station. Because the failure event has been stored in the non-volatile memory 121, the administrator will be able to quickly identify the cause of the problem at a later point.

The storing of the state of the computer system 150 can also be particularly helpful in the event of a periodically recurring failure. In some cases, the monitoring system 100 will detect a transitory event, such as the overheating of a power supply. In this situation, if the computer system 150 is shut down and brought to a repair desk, but is not examined immediately, the power supply may cool down to an acceptable level. Then, when the computer system 150 is later tested, the power supply may not overheat again for some time. By retaining a log of the detected event (e.g., the overheated power supply), a technician can immediately view the status indication on the display 110 that had initially caused the computer system 150 to be removed from deployment. This will aid the technician in diagnosing and resolving the problem.

Remote Management

As described above, the monitoring system 100 is configured to operate independently of the computer system 150 being monitored. Thus, if the computer system 150 crashes or experiences some other type of the failure, the monitoring system 100 can continue to monitor and report on the status of the computer system.

In accordance with embodiments of the present invention, the monitoring system 100 may be used to actively manage the computer system 150, in addition to merely monitoring the status of its operation. The controller 120 may be configured to receive management commands from the management system 200 via the network interface 123 or via the computer system's network interface 164. If the computer system's network interface 164 is used, the computer system's OS is used to relay communications to the controller 120. If the monitoring system's network interface 123 is used, the computer system's OS may be bypassed for out-of-band communication, thereby enabling communication between the management system 200 and the monitoring system 100, even when the monitored computer system 150 has failed or is otherwise unavailable.

The monitoring system 100 may be configured to cause the computer system 150 to reboot or shut down, in the event that a failure has been detected. The instruction to reboot or shut down may be issued to the monitoring system 100 by an administrator at the remote management system 200. After the reboot or shut down command is received, the monitoring system 100 can transmit a signal to the appropriate lead in the motherboard interface 106. This signal will be transmitted to the switchboard interface 164 on the motherboard 160 in the same way that a signal would be transmitted if a user were to push the power or reset buttons on the switchboard 170 in a conventional computer system.

As described above, management system platforms have been developed for remotely managing computer systems. One such management platform is defined by the IPMI standard. A limitation of such management platforms is that the computer system 150 to be monitored must be configured to respond to the commands from the remote management system. This typically requires that the motherboard chipset be compliant with a predefined specification.

In accordance with embodiments of the present invention, the monitoring system 100 may be used as a translator to receive commands from a remote management system 200 according to a first messaging protocol that is not supported by the computer system 150 being monitored. The monitoring system 100 then converts the management command to an instruction according to a second protocol that computer system 150 can support. This instruction can then be transmitted to the motherboard 160 via standard serial interfaces 104 and 163, thus eliminating the need for a custom dedicated interface for the monitoring system 100. This translation can be accomplished using software executed on the controller 120.

This translation functionality may be particularly useful for customers that wish to utilize the features provided by a management system specification, such as IPMI, but want the flexibility to implement the management system with standard, non-IPMI compliant computer hardware. This enables the customer to obtain the benefits of sophisticated management systems while utilizing low-cost, off-the-shelf hardware.

In addition, the use of a programmable controller 120 and the standard serial interfaces enables the monitoring system 100 to be used with a variety of different types of management systems 200 and computer systems 150. As new types of management systems and management functionality emerge, the controller 120 can be reprogrammed to respond to the management commands and to translate those instructions into commands that are interpretable by the computer system 150.

Asset Tracking

As described above, the monitoring system 100 may be utilized for a variety of monitoring functions. In accordance with some embodiments, the monitoring system 100 may be used for tracking purposes.

In most cases, the computer systems deployed in large data centers are not all deployed at the same time and/or may not have the same hardware or software configurations. As the number of computer systems deployed increases, the difficulty of tracking these computer systems also increases. One conventional method of tracking is to attach a barcode sticker to each computer system. Each barcode uniquely identifies each computer system, and a database is used to store the barcode number with the computer system's deployment and configuration information. A disadvantage of this approach is that the information cannot be easily obtained by casual inspection of the computer system. The barcode must first be scanned, and the database queried with the scanned barcode number in order to obtain the desired information.

In accordance with embodiments of the present invention, the display 110 of the monitoring system 100 is used to provide tracking information regarding the computer system 150. One type of tracking information that might be displayed is the chronological status of the computer system 150. The chronological status may refer to the length of time from when the computer system 150 was first assembled, the time from when the computer system 150 was last updated, the time from when the computer system 150 was last rebooted, or any other time period of interest. For example, the chronological status may indicate one of a plurality of milestones during the manufacturing or testing process.

The chronological status may be displayed in a variety of ways. For example, when using a display 110 including a tri-color LED 112, the color of the LED 112 may represent the passage of time. For example, if the computer system 150 has been in service for less than three months, the LED 112 will be illuminated with a green color. If the computer system 150 has been in service for more than three months but less than one year, the LED 112 may be illuminated with a yellow color. Finally, if the computer system 150 has been in service for more than one year, the LED 112 may be illuminated with a red color, which would indicate that the computer system 150 should be removed from service. In other embodiments, different time periods representing different chronological states may be displayed using different sequences and timing of color illumination.

The chronological status may also be utilized to improve the ease with which tests are run on computer systems 150. For example, when a computer system is first assembled, it may be tested for a time period specified by the manufacturer or by the customer. The display 110 can be used to indicate whether the specified time period has passed. For example, if a computer system must be operated for 100 hours continuously before being shipped, the controller 120 may be configured to illuminate the display 110 a first color (e.g., green) while the test is being performed, and to illuminate the display 110 a second color (e.g., blue), once the 100 hours has passed successfully without any detected failures. The controller 120 may be further configured to illuminate the display 110 a third color (e.g., red) if a failure is detected before the specified time period expires.

The use of a single color to represent the chronological status of the computer system 150 may be particularly desirable for large scale deployments. This would enable a technician to very quickly and easily scan rows of rack-mounted computer systems to determine whether any of the system have exceeded the desired service time threshold.

In another embodiment, the display 110 may utilize different colors, sequences, or timings to provide identification information for the computer system 150. This identification information may be, e.g., an indication of the function of the computer system 150. For example, in a data center, a first set of computer systems 150 may be utilized as file servers, while a second set of computer systems 150 may be utilized as application servers. The file servers may be identified using a first color and the application servers may be identified using a second color. This can improve the ease with which technicians can identify the computer systems that require servicing.

Software Lockout of Physical Switches

In accordance with some embodiments of the present invention, the monitoring system 100 may be used to provide software-based control over physical controls on the computer system 150.

Most conventional computer systems are provided with physical controls to provide users with some manual control over the operation of the computer system. The most common controls are the power switch/button and reset button, which can be provided on a switchboard 170 and accessed from the front or back side of the computer chassis. Normally, when a user presses the power switch 172, a power signal is transmitted to a power pin in the switchboard interface 164. The firmware implemented on the motherboard 160 will detect this signal and begin a power up or power down process. Similarly, when a user presses the reset switch 174, a reset signal is transmitted to a reset pin in the switchboard interface 164. Typically, the firmware on the motherboard 160 will cause the computer system 150 to reset.

In some computer systems, the software operating system being executed by the CPU 166 may intercept these power and reset signals and initiate a software-controlled power or reset process. This may be done in order to allow the computer system to shut down gracefully, rather than through a sudden cessation of power.

In typical datacenter installation, large numbers of computer systems are housed together in a single room. When a fault is detected in one of the computer systems, a technician may be instructed to locate the failed computer system, power the system down, pull the system from the rack, and transport it to a service station where the problem can be diagnosed and repaired. Due to the large number computer systems in the datacenter, the technician may accidentally locate the wrong computer system. Thus, the technician may power down and retrieve a computer system that is functioning properly.

In accordance with embodiments of the present invention, the monitoring system 100 can be used to provide a software-based lockout of the power switch 172, the reset switch 174, or any other physical controls on the computer system. Normally, these physical controls are directly connected to pins on the motherboard 160. However, as shown in FIG. 1, the monitoring system 100 is interposed between the physical controls (e.g., power switch 172 and reset switch 174) and the motherboard 160. Thus, the monitoring system 100 can receive commands remotely (e.g., from management system 200) to activate or deactivate the physical controls.

In one example, the management system 200 may instruct all of the monitoring systems 150 to deactivate the power switch 172 and reset switch 174 for all of the computer systems 150 in the datacenter. Thus, no one will be able to manually power down or reset any of the computer system 150. When it is desired that one of the computer systems 150 be retrieved (e.g., if a failure is detected in that system), the management system 200 will transmit a message to the monitoring system 100 for the failed computer system 150 indicating that the power switch 172 should be activated. Thus, if the technician attempts to shut down the wrong computer system 150, the power switch 172 will not work. Only the power switch 172 for the failed computer system 150 will be operational. This can help to prevent inadvertent or unwanted attempts to shut down the other computer systems 150.

Transient Barcode

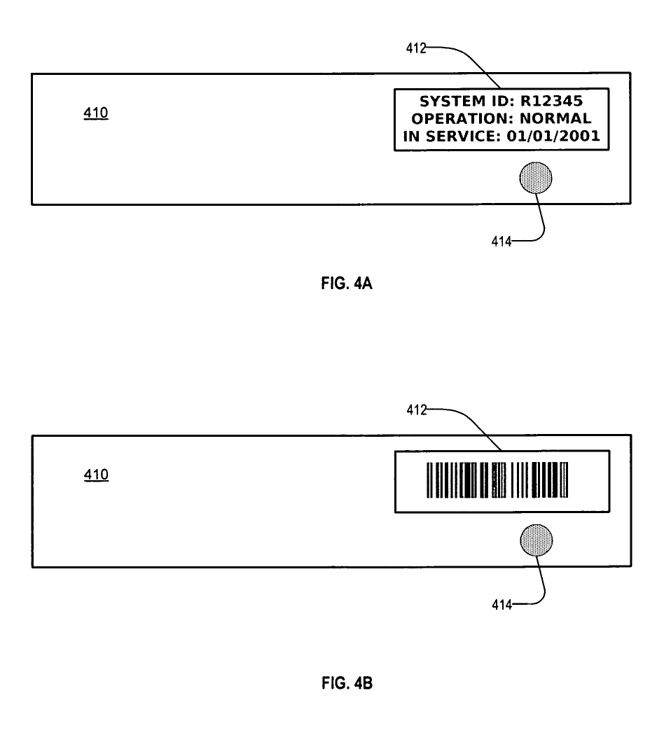

The monitoring system 100 may be configured to selectively display a barcode that can be read by a barcode scanner. FIGS. 4A-4B illustrate a display 410 for displaying a barcode, in accordance with embodiments of the present invention

In this embodiment, the display 410 displays the barcode using, e.g., an LCD screen 412. This LCD screen 412 may supplement or replace the LEDs, described above with respect to FIG. 1. Because of the resolution capabilities of LCD technology, the LCD display 412 may be used to display textual information, rather than simply colors, as with the LEDs 112. This textual information may include, e.g., a system identification number, a status of the computer system, and chronological status information.

Due to the limited space available on the front of the computer system 150, it may be desirable to minimize the size of the LCD display 412. Therefore, the LCD display 412 may not be large enough to display both text and a barcode simultaneously. In addition, it would generally not be necessary to display both text and the barcode simultaneously because the display 410 would generally be read by a human or scanned by a barcode scanner, but not both simultaneously. Therefore, it would be desirable to maximize the amount of textual information that can be displayed on the LCD display 412.

Accordingly, it may be desirable for the controller 120 to selectively display a barcode in place of the textual information. This can be accomplished by providing the monitoring system 100 with a sensor 414 that is responsive to the light emitted by a barcode scanner. When the controller 120 detects that light from a barcode scanner is striking the sensor 414, the controller 120 will remove the textual information from the LCD display 412 and replace it with a barcode. Thus, when the computer system is deployed, a technician can travel from system to system with a barcode scanner. When the scanner is aimed towards the LCD display 412 and activated, the LCD display 412 will automatically switch from text to a barcode, without requiring any further intervention by the technician.

Thus, the monitoring system 100 is able to maximize the amount of information that can be conveyed by the display 410. When a barcode scanner is not being used, the entire surface of the LCD display 412 can be used to display textual information. When the presence of a barcode scanner is detected, the entire LCD display 412 can be dedicated to displaying the barcode.

RF Interface

In accordance with embodiments of the present invention, the monitoring system 100 may further be configured to transmit status information regarding the computer system 150 via an RF (radio frequency) interface 122. This RF interface 116 may transmit messages using a short or long range wireless protocol, such as, e.g., IEEE 802.11 (“WiFi”), IEEE 802.15.1 (“Bluetooth”), ultra wideband (UWB) radio, and the like.

Embodiments of the present invention may provide various advantages not provided by prior art systems. The computer system being monitored by the monitoring system need not have its own network connection in order to convey information regarding the status of the computer system. The monitoring system may be provided with its own network interface and communications capability, so that the monitoring system may communicate directly with the management system. In addition, the monitoring system may be provided with a display that is configured to visually indicate a plurality of different types of information regarding the state of the computer system. This can be particularly useful for testing newly assembled computer systems prior to shipment to customers.

In addition, by utilizing simple LEDs or small LCD displays to display status information, the cost of the monitoring systems can be reduced, while still providing the ability to convey a significant amount of information. In addition, the amount of space consumed on the front side of the computer system can also be reduced.

While the invention has been described in terms of particular embodiments and illustrative figures, those of ordinary skill in the art will recognize that the invention is not limited to the embodiments or figures described. For example, in many of the embodiments described above, the display has been described as being implemented using LEDs or LCDs. In other embodiments, the display may utilize any of a variety of technologies for visually displaying information about the monitored computer system, and need not be limited to LEDs and LCDs. For example, conventional incandescent light bulbs may be used, although this may be undesirable due to the cost and size of utilizing incandescent bulbs.

In addition, in other embodiments, the monitoring system 100 may include greater or fewer interfaces for connection with the motherboard 160 and other components. For example, the monitoring system 100 may include a system management interface to connect with a motherboard-based system management bus, such as, e.g., an SMBus or an 12C (Inter-Integrated Circuit) Bus. This system management interface can be used by the monitoring system 100 to collect data about the status of the computer system 150, and to control devices within the computer system 150, such as fans and power supplies.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A monitoring system for providing status information about a computer system, comprising:
a system interface configured to couple with a corresponding interface on a motherboard of the computer system;
a display to visually indicate a status of the computer system;
a nonvolatile memory;
a network interface for connection with a data communications network; and
a programmable controller configured to communicate with a management system via the network interface, to cause the display to indicate a status of the computer system, and to store the status of the computer system in the nonvolatile memory.

2. The system of claim 1, wherein:
the programmable controller is configured to detect a condition of the computer system via the system interface and to display an indication of the detected condition on the display.

3. The system of claim 1, wherein:
the programmable controller is configured to transmit messages via the interface to a system bus in the computer system.

4. The system of claim 1, wherein:
the interface comprises a serial interface to the motherboard of the computer system.

5. The system of claim 1, wherein:
said display comprises one or more multi-color light emitting diodes (LEDs).

6. The system of claim 5, wherein:
said programmable controller is configured to activate the LEDs in a plurality of unique color and timing combinations, each combination representing a different status of the computer system.

7. The system of claim 1, wherein:
said programmable controller is configured to activate the display to indicate a chronological status of the computer system.

8. The system of claim 7, wherein:
said chronological status corresponds to a length of time the computer system has been in operation.

9. The system of claim 7, wherein:
said chronological status corresponds to a length of time a test has been operating on the computer system.

10. The system of claim 1, further comprising:
wherein said programmable controller is configured to activate the display in response to instructions received via the network interface.

11. The system of claim 1, further comprising:
wherein the programmable controller is configured to detect a condition of the computer system and to transmit a message to a management system via the network interface regarding the detected condition.

12. The system of claim 1, wherein:
the interface, the display, and nonvolatile memory, and the programmable controller are provided on a printed circuit board.

13. The system of claim 1, further comprising:
a radio frequency (RF) transmission module configured to transmit information regarding the status of the computer system.

14. The system of claim 1, further comprising:
a sensor for detecting a beam from a barcode scanner;
wherein said programmable controller is configured to change an image on the display from a human-readable text image to a barcode image upon detection of the beam from the barcode scanner.

15. The system of claim 1, wherein:
said display is configured to display a barcode image and a human-readable text image.

16. The system of claim 15, further comprising:
a sensor for detecting a beam from a barcode scanner;
wherein said programmable controller is configured to change an image on the display from a human-readable text image to a barcode image upon detection of the beam from the barcode scanner.

17. A monitoring system for providing status information about a computer system, comprising:
a system interface configured to couple with a corresponding interface on a motherboard of the computer system;
a display to visually indicate a status of the computer system, said display being configured to display a barcode image and a human-readable text image;
a sensor for detecting a beam from a barcode scanner;
a controller configured to cause the display to indicate a status of the computer system, said programmable controller being configured to change an image on the display from a human-readable text image to a barcode image upon detection of the beam from the barcode scanner.

18. The system of claim 17, wherein:
said display comprises a liquid crystal diode (LCD) display.

19. A monitoring system for a computer system, comprising:
a serial interface configured to couple with a corresponding serial interface on a motherboard of the computer system;
a display to visually indicate a status of the computer system;
a network interface for connection with a data communications network; and
a programmable controller configured to cause the display to indicate a status of the computer system, wherein the programmable controller is configured to receive a management command via the network interface in accordance with a first messaging protocol, to convert the management command to an instruction according to a second messaging protocol, and to transmit the instruction to a device in the computer system via the serial interface.
